(19) United States
(12) Patent Application Publication
(10) Pub. No.: US 2021/0301167 A1
(43) Pub. Date: Sep. 30, 2021

(54) Treatment Liquid Composition, Printing Method, Composition Set, And Cloth

(71) Applicant: Seiko Epson Corporation, Toyko (JP)

(72) Inventors: Hideki OKADA, Shiojiri (JP); Akiko YAMADA, Shiojiri (JP)

(21) Appl. No.: 17/215,046

(22) Filed: Mar. 29, 2021

(30) Foreign Application Priority Data
Mar. 30, 2020 (JP) 2020-060115

(51) Int. Cl. C09D 11/54; C09D 11/102; B41M 5/00; B41M 7/00

(52) U.S. Cl. CPC C09D 11/54; C09D 11/102; B41M 5/0023; B41M 7/009; B41M 5/0047

(57) ABSTRACT

A treatment liquid composition is used by being applied to a cloth. The treatment liquid contains an aliphatic diisocyanate, at least one compound selected from the group consisting of multivalent metal salts and cationic polymers, and water.

The present application is based on, and claims priority from JP Application Serial Number 2020-060115, filed Mar. 30, 2020, the disclosure of which is hereby incorporated by reference herein in its entirety.

### BACKGROUND

### 1. Technical Field

The present disclosure relates to a treatment liquid composition, a printing method, a composition set, and a cloth.

### 2. Related Art

Various aqueous ink jet compositions are being developed for ink jet textile printing. In general, aqueous ink jet ink compositions used for textile printing contain color materials for forming desired color images. The color materials include dyes and pigments, and many of the color materials are water-insoluble disperse dyes and pigments.

When an ink composition containing a disperse color material is applied onto a cloth, the disperse color material penetrates deep in the cloth and results in insufficient color development. JP-A-2018-165417 discloses a pretreatment liquid that caused the color material in the ink composition to flocculate and remain at the cloth surface. This pretreatment liquid contains either a resin dispersion or a crosslinking agent or both, a slip additive, and water.

Unfortunately, images formed with the color material distributed at the cloth surface are likely to be insufficient in fastness to rubbing, particularly to wet rubbing. In textile printing using disperse color materials, the color development and the rub fastness of printed images depend on the position of the color material in the cloth and are in a relationship of trade-off. In textile printing with ink jet ink compositions containing disperse color materials, accordingly, it is desired to increase both the color development and the rub fastness of the printed image.

### SUMMARY

According to an aspect of the present disclosure, a treatment liquid composition used by being applied to a cloth is provided. The treatment liquid contains an aliphatic diisocyanate, at least one compound selected from the group consisting of multivalent metal salts and cationic polymers, and water.

According to another aspect of the present disclosure, a printing method is provided which includes an application step of applying an ink jet ink composition containing a disperse color material and resin particles onto a cloth with the treatment liquid composition applied thereto, and a heating step of heating the cloth after the application step.

An aspect of the present disclosure is directed to a composition set including the above-described treatment liquid composition and an ink jet ink composition containing a disperse color material and resin particles.

Also, another aspect of the present disclosure is directed to a cloth with the treatment liquid applied thereto.

### DESCRIPTION OF EXEMPLARY EMBODIMENTS

Some of the embodiments of the present disclosure will now be described. The following embodiments illustrate some implementations of the present disclosure. The subject matter of the present disclosure is not limited to the following embodiments, and various modifications may be made within the scope and spirit of the disclosure. Not all the components disclosed in the following embodiments are necessarily essential for the implementation of the subject matter.

### 1. Treatment Liquid Composition

The treatment liquid composition disclosed herein is used by being applied to a cloth and contains an aliphatic diisocyanate, at least one compound selected from the group consisting of multivalent metal salts and cationic polymers, and water.

### 1. 1. Aliphatic Diisocyanate

The aliphatic diisocyanate is an aliphatic compound to which two isocyanate groups, two blocked isocyanate groups, or one isocyanate and one blocked isocyanate are bound.

Aliphatic compounds are acyclic or cyclic carbon compounds not having aromaticity. An acyclic carbon compound is a compound having a straight, branched, or cyclic molecular chain. Such molecular chains may be saturated or unsaturated. The aliphatic compound may be substituted or may be coupled to a high-molecular-weight compound with a substituent therebetween. The aliphatic compound may be a simple hydrocarbon or a hydrocarbon to which one or more heteroatoms, such as oxygen, nitrogen, sulfur, or chlorine, are bound. Beneficially, the two isocyanates of the aliphatic diisocyanate are bound to a chain containing no oxygen or nitrogen, and the chain may be a hydrocarbon. In some embodiments, the aliphatic compound is a hydrocarbon from the viewpoint of improving both color development and rub fastness.

One or both isocyanate groups of the aliphatic diisocyanate may be in a blocked form. In the description disclosed herein, aliphatic diisocyanates whose one or both isocyanate groups are in a blocked form are also referred to as aliphatic diisocyanate.

The isocyanate group is reactive and, in an aqueous medium, easily reacts with water, thus being unstable. However, blocked isocyanate groups protected by protective groups are stable and can be stably used even in aqueous media. In other words, the isocyanate group, which is originally reactive, is allowed to be present stably in aqueous media by being masked (protected) with a blocking agent.

When being heated in an aqueous medium, the blocked isocyanate group releases the blocking agent (protective groups) and returns to the isocyanate group that is reactive with substances having active hydrogen, such as cellulose.

Blocked isocyanate groups are isocyanate groups protected by protective groups. Aliphatic diisocyanates having one or two blocked isocyanate groups are more stable in water than non-blocked diisocyanates. Such an aliphatic diisocyanate can be stable in the treatment liquid composition, consequently increasing the storage stability of the treatment liquid composition. In addition, even though the treatment liquid composition contains a cationic polymer (described later herein) and resin particles (described later herein), the aliphatic diisocyanate having one or two blocked isocyanates is less likely to react with these constituents, maintaining the isocyanate groups that will be involved in the reaction with the cloth. Furthermore, the reaction timing of blocked isocyanate groups can be controlled by, for example, inducing the reaction by heating.

Examples of the blocking agent that can form protective groups include 3,5-dimethylpyrazole, diethyl malonate, methyl ethyl ketoxime, ϵ-caprolactam, and 1,2,4-triazole. Aliphatic diisocyanates whose one or both isocyanate groups are protected with a blocking agent can be present stably in aqueous media. The blocked isocyanate groups are turned into isocyanate groups reactive with hydroxy, amino, and other groups by heating.

The isocyanate group is reactive with substances having hydroxy groups, such as cellulose. Also, the isocyanate group can react with groups other than the hydroxy group, and such a reaction can be controlled by temperature or concentration. The cloth to which the treatment liquid will be applied may contain cellulose. In this instance, the isocyanate groups of the aliphatic diisocyanate react with the hydroxy groups of the cellulose to form urethane bands, thus chemically binding the aliphatic diisocyanate to the cellulose. The degree of reaction with cellulose or the like can be controlled by controlling the degree of heating or the concentration of the aliphatic diisocyanate. For example, after the treatment liquid composition is applied to the cloth, some or all blocked isocyanate groups may be kept unreacted on the cloth.

The isocyanate groups react with hydroxy groups to form urethane bonds. However, the isocyanate groups do not always react with hydroxy groups and may react with other groups or species depending on the reaction target. For example, a reaction of an isocyanate group with an amino group forms a urea bond; a reaction of a plurality of isocyanate groups with water forms urea bonds; a reaction of a urea bond with an isocyanate group forms a biuret bond; and a reaction of a urethane bond with an isocyanate group forms an allophanate bond. Since these bonds can be positively formed or be inhibited from forming by, for example, controlling the reaction temperature, what bond is to be formed can be determined depending on the chemical structure contained in the object to which the aliphatic diisocyanate is to be applied.

The aliphatic diisocyanate content in the treatment liquid composition may be 0.1% to 15.0%, for example, 0.2% to 10.0% or 0.2% to 5.0%, relative to the total mass of the treatment liquid composition, and in some embodiments, may be 0.5% to 2.0%. When the aliphatic diisocyanate content is in such a range, an appropriate amount of isocyanate groups can be distributed to and bound to the cloth by applying the treatment liquid composition. The isocyanate groups then react with one or more constituents of an ink jet ink composition, for example, when the ink jet ink composition is applied onto the cloth and heated. Thus, the disperse color material in the ink jet ink composition becomes unlikely to separate from the cloth, and the printed image can exhibit high fastness to rubbing.

Exemplary acyclic aliphatic diisocyanates include tetramethylene diisocyanate, dodecamethylene diisocyanate, 1,5-pentamethylene diisocyanate, hexamethylene diisocyanate, 2,2,4-trimethylhexamethylene diisocyanate, 2,4,4-trimethylhexamethylene diisocyanate, lysine diisocyanate, 2-methylpentane-1, 5-diisocyanate, and 3-methylpentane-1,5-diisocyanate.

Exemplary cyclic alicyclic diisocyanates include isophorone diisocyanate, hydrogenated xylylene diisocyanate, dicyclohexylmethane diisocyanate, 1,4-cyclohexane diisocyanate, methylcyclohexylene diisocyanate, and 1,3-bis(isocyanatomethyl)cyclohexane.

Such aliphatic diisocyanates may be used individually or in combination.

From the viewpoint of suppressing discoloration, a substituted or unsubstituted alkylene diisocyanate may be used. In some embodiments, the aliphatic diisocyanate is an unsubstituted alkylene diisocyanate. More specifically, the aliphatic diisocyanate may be selected from among 1,5-pentamethylene diisocyanate, 1,6-hexamethylene diisocyanate, 4,4′-dicyclohexylmethane diisocyanate, isophorone diisocyanate, and 1,3-bis(isocyanatomethyl)cyclohexane. In some embodiments, 1,6-hexamethylene diisocyanate may be selected because of availability.

The aliphatic diisocyanate may be available in the form of a water dispersion of a nonionic or cationic aliphatic diisocyanate. A water dispersion refers to a dispersion of a substance in water. The aliphatic diisocyanate in such a form can be kept dispersed stably in the treatment liquid composition. Accordingly, the treatment liquid composition can be preserved for a long time, thus maintaining the reactivity.

Examples of the water dispersion of a nonionic or cationic aliphatic diisocyanate include MEIKANATE NBP-211 (nonionic), MEIKANATE CX (cationic), MEIKANATE NBP-873D (nonionic), and MEIKANATE SU-315V (nonionic) (all produced by Meisei Chemical Works). A water dispersion of an anionic aliphatic diisocyanate may be used, and an example thereof is MEIKANATE SU-268A (produced by Meisei Chemical Works).

Diisocyanates, which have two isocyanate groups in the molecule, can function as a crosslinking agent. In the present disclosure, diisocyanates are often referred to as crosslinking agents.

### 1. 2. Multivalent Metal Salts and Cationic Polymers

The treatment liquid composition also contains at least one compound selected from the group consisting of multivalent metal salts and cationic polymers. Multivalent metal salts and cationic polymers can flocculate one or more constituents of the ink jet ink composition when the treatment liquid composition comes into contact with the ink jet ink composition. In the present disclosure, multivalent metal salts and cationic polymers may be referred to as flocculants.

The multivalent metal salt and cationic polymer contained in the ink jet ink composition flocculate the disperse color material, resin particles, and the like in the ink jet ink composition. The degree of flocculation of the disperse color material and resin particles by the multivalent metal salt or cationic polymer depends on the species and concentration of the multivalent metal salt, the cationic polymer, the disperse color material, and the resin particles and can be controlled. Such flocculation enhances the color development of the disperse color material and increases the fixability of the color material and resin particles and the viscosity of the ink jet ink composition.

Multivalent metal salts are composed of a divalent or higher-valent metal ion and an anion. Examples of the divalent metal ion include calcium ion, magnesium ion, copper ion, nickel ion, zinc ion, barium ion, aluminum ion, titanium ion, strontium ion, chromium ion, cobalt ion, and ferrous ion. In some embodiments, at least either the calcium ion or the magnesium ion may be selected as the metal ion of the multivalent metal salt. Calcium and magnesium ions are beneficial for flocculating one or more constituents of the ink jet ink composition.

The counter anion of the multivalent metal salt may be an inorganic anion or an organic anion. Hence, the multivalent metal salt used in the treatment liquid composition is a salt composed of an inorganic or organic anion and a multivalent metal ion. Examples of the inorganic anion include chloride ion, bromide ion, iodide ion, nitrate ion, sulfate ion, and hydroxide ion. Examples of the organic anion include organic acid ions, such as carboxylate ions.

The multivalent metal salt may be a magnesium salt or a calcium salt. Magnesium and calcium salts can stabilize the treatment liquid composition. Also, the counter ion of the multivalent metal ion may be an inorganic acid ion or an organic acid ion.

Examples of the multivalent metal salt include, but are not limited to, calcium carbonate (heavy calcium carbonate and light calcium carbonate), calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium acetate, magnesium acetate, and aluminum acetate. These multivalent metal salts may be used individually or in combination. Magnesium sulfate, calcium nitrate, and calcium chloride are highly soluble in water and thus beneficial, and at least one thereof may be selected. In some embodiments, calcium nitrate or calcium chloride may be used. The raw material of the metal salt may contain hydrated water.

Examples of the cationic polymer include cationic urethane resin, cationic olefin resin, and cationic amine resin. The cationic polymer may be soluble in water.

A commercially available cationic urethane resin may be used, and examples thereof include HYDRAN series CP-7010, CP-7020, CP-7030, CP-7040, CP-7050, CP-7060, and P-7610 (all produced by DIC); SUPERFLEX series 600, 610, 620, 630, 640, and 650 (all produced by DKS); and Urethane Emulsions WBR-2120C and WBR-2122C (both produced by Taisei Fine Chemical).

Cationic olefin resin has a skeleton containing an olefin, such as ethylene or propylene. Any known olefin resin may be used as required. The cationic olefin resin may be dispersed in a liquid medium, such as water or an organic solvent, thus being in the form of an emulsion. A commercially available cationic olefin resin may be used, and examples thereof include ARROWBASE series CB-1200 and CD-1200 (both produced by Unitika).

The cationic amine resin is not particularly limited provided that it has an amino group in the molecule and may be selected from among known cationic amines. For example, the cationic amine resin may be polyamine resin, polyamide resin, or polyallylamine resin. Polyamine resin is a resin having an amino group in the main skeleton of the resin. Polyamide resin is a resin having an amide group in the main skeleton of the resin. Polyallylamine resin is a resin having a structure derived from the allyl group in the main skeleton of the resin.

Examples of the cationic polyamine resin include UNISENCE KHE 103L (aqueous solution of hexamethylenediamine-epichlorohydrin resin with a solid content of 50% by mass, 1% aqueous solution thereof has a pH of about 5.0 and a viscosity of 20 mPa·s to 50 mPa·s) and UNISENCE KHE104L (aqueous solution of dimethylamine-epichlorohydrin resin with a solid content of 20% by mass, 1% aqueous solution thereof has a pH of about 7.0 and a viscosity of 1 mPa·s to 10 mPa·s), both produced by SENKA Corporation. Other cationic polyamine resins are also commercially available, and examples thereof include FL-14 (produced by SNF), ARAFIX series 100, 251S, 255, and 255LOX (all produced by Arakawa Chemicals), DK-6810, DK-6853, DK-6885, WS-4010, WS-4011, WS-4020, WS-4024, WS-4027, and WS-4030 (all produced by Seiko PMC Corporation), PAPYOGEN P-105 (produced by SENKA Corporation), SUMIREZ Resins 650(30), 675A, 6615, and SLX-1 (all produced by Taoka Chemical), CATIOMASTER (registered trademark) series PD-1, PD-7, PD-30, A, PDT-2, PE-10, PE-30, DT-EH, EPA-SK01, and TMHMDA-E (all produced by Yokkaichi Chemical), and JETFIX series 36N, 38A, and 5052(all produced by Satoda Chemical Industrial).

Examples of the polyallylamine resin include polyallylamine hydrochloride, polyallylamine amidosulfate, allylamine hydrochloride-diallylamine hydrochloride copolymer, allylamine acetate-diallylamine acetate copolymer, allylamine hydrochloride-dimethylallylamine hydrochloride copolymer, allylamine-dimethylallylamine copolymer, polydiallylamine hydrochloride, polymethyldiallylamine hydrochloride, polymethyldiallylamine amidosulfate, polymethyldiallylamine acetate, polydiallyldimethylammonium chloride, diallylamine acetate-sulfur dioxide copolymer, diallylmethylethylammonium ethylsulfate-sulfur dioxide copolymer, methyldiallylamine hydrochloride-sulfur dioxide copolymer, diallyldimethylammonium chloride-sulfur dioxide copolymer, and diallyldimethylammonium chloride-acrylamide copolymer.

Commercially available cationic polyallylamine resins include PAA-HCL-03, PAA-HCL-05, PAA-HCL-3L, PAA-SA, PAA-03, PAA-05, PAA-08, and PAA-D41-HCL (all produced by Nittobo Medical).

A plurality of such flocculants may be used in combination irrespective of whether multivalent metal salts or cationic polymers. The above-cited flocculants can favorably flocculate the treatment liquid composition and thus help ink jet ink compositions to form highly developed color images when the ink compositions come into contact with the cloth with the treatment liquid composition applied thereto.

The total flocculant content (total of multivalent metal salts and cationic polymers) may be 0.1% to 10.0%, for example, 0.5% to 5.0% or 1.0% to 3.0%, relative to the total mass of the treatment liquid composition. Even when a flocculant in the form of a solution or a dispersion is added into the treatment liquid composition, the flocculant content in terms of solid content may be in such a range.

When the flocculant content is 0.1% by mass or more, the flocculant can sufficiently flocculate one or more constituents of the ink jet ink composition on the cloth. In addition, when the flocculant content is 10.0% by mass or less, the flocculant is likely to dissolve or disperse sufficiently in the treatment liquid composition, increasing the storage stability of the treatment liquid composition.

### 1. 3. Water

The treatment liquid composition disclosed herein also contains water. The water may be pure water or ultra-pure water from which ionic impurities have been removed as much as possible. Examples of such water include ion exchanged water, ultrafiltered water, reverse osmosis water, and distilled water. Sterile water prepared by, for example, UV irradiation or addition of hydrogen peroxide can prevent the occurrence of bacteria and Eumycota in the treatment liquid composition over a long time.

The water content may be 70.0% or more, for example, 80.0% or more or 90.0% or more, relative to the total mass of the treatment liquid composition. When the water content is 70.0% by mass or more, the treatment liquid composition has a relatively low viscosity and becomes easy to apply to the cloth. The upper limit of the water content may be 99.0% or less, for example, 98.0% or less or 97.0% or less, relative to the total mass of the treatment liquid composition.

### 1. 4. Optional Constituents

The treatment liquid composition may optionally contain the following constituents in addition to the above-described constituents.

### 1. 4. 1. Resin Particles

The treatment liquid composition may further contain resin particles. When the ink jet ink composition is applied onto the cloth with the treatment liquid applied thereto, the resin particles fix some constituents of the ink jet ink composition to the cloth. In addition, the resin particles may help the constituents of the treatment liquid composition to keep attached to the cloth.

Examples of the material of the resin particles include urethane resin, acrylic resin, fluorene resin, polyolefin resin, rosin-modified resin, terpene resin, polyester resin, polyamide resin, epoxy resin, vinyl chloride resin, and ethylene vinyl acetate resin. The resin particles are often used in the form of emulsion but may be in the form of powder. The resin particles may be made of an individual material or a plurality of materials. Resin particles may be referred to as polymer particles.

Urethane resin is a generic term for resins having urethane bonds. The urethane resin used herein may have other bonds in the main chain, in addition to the urethane bond, and examples of such a urethane resin include a polyether-type urethane resin having an ether bond, a polyester-type urethane resin having an ester bond, and a polycarbonate-type urethane resin having a carbonate linkage. Commercially available urethane resins may be used, and examples thereof include SUPERFLEX series 210, 460, 460s, 620, 840, and E-4000 (all produced by DKS), RESAMINE series D-1060, D-2020, D-4080, D-4200, D-6300, and D-6455 (all produced by Dainichiseika Color & Chemicals Mfg.), TAKELAC series WS-6020, WS-6021, and W-512-A-6 (all produced by Mitsui Chemicals), SANCURE 2710 (produced by Lubrizol), and PERMARIN UA-150 (produced by Sanyo Chemical Industries).

Acrylic resin, which is a generic term for polymers obtained by polymerizing one or more acrylic monomers, such as (meth)acrylic acid and (meth)acrylic acid esters, may be a resin produced from one or more acrylic monomers or a copolymer produced from one or more acrylic monomers and other monomers. Acrylic-vinyl resin, which is a copolymer of an acrylic monomer and a vinyl monomer, is one example of such a copolymer. More specifically, such an acrylic-vinyl resin may be a copolymer with a vinyl monomer, such as styrene. Other acrylic monomers include acrylamide and acrylonitrile.

Commercially available acrylic resin emulsions may be used, and examples thereof include FK-854, MOWINYL 952B, and MOWINYL 718A (all produced by Japan Coating Resin), Nipol LX852 and Nipol LX874 (both produced by Nippon Zeon), POLYSOL AT860 (produced by Showa Denko), and VONCOAT series AN-1190S, YG-651, AC-501, AN-1170, and 4001 (all acrylic emulsions produced by DIC).

The acrylic resin may be a styrene-acrylic resin as mentioned above. The term (meth)acrylic (or (meth)acrylate) used herein refers to at least one of acrylic (or acrylate) and methacrylic (or methacrylate).

Styrene-acrylic resin is a type of copolymer produced from one or more styrene monomers and one or more acrylic monomers, and examples thereof include styrene-acrylic acid copolymers, styrene-methacrylic acid copolymers, styrene-methacrylic acid-acrylate copolymers, styrene-a-methylstyrene-acrylic acid copolymers, and styrene-a-methylstyrene-acrylic acid-acrylate copolymers. Commercially available styrene-acrylic resins may be used, and examples thereof include JONCRYL series 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (all produced by BASF), and MOWINYL series 966A and 975N (both produced by Japan Coating Resin).

The vinyl chloride resin may be a vinyl chloride-vinyl acetate copolymer.

Polyolefin resin is a type of resin having a skeleton containing an olefin, such as ethylene, propylene, or butylene, and a known polyolefin resin may be used. Commercially available polyolefin resins may be used, and examples thereof include ARROWBASE series CB-1200 and CD-1200 (both produced by Unitika).

The resin particles may be in the form of an emulsion, and commercially available resin emulsions include Micro Gel E-1002 and Micro Gel E-5002 (both styrene-acrylic resin emulsion produced by Nippon Paint); VONCOAT series AN-1190S, YG-651, AC-501, AN-1170, 4001, and 5454 (styrene-acrylic resin emulsion produced by DIC); Polysol series AM-710, AM-920, AM-2300, AP-4735, AT-860, and PSASE-4210E (acrylic resin emulsion), Polysol AP-7020 (styrene-acrylic resin emulsion), Polysol SH-502 (vinyl acetate resin emulsion), Polysol series AD-13, AD-2, AD-10, AD-96, AD-17, and AD-70 (ethylene-vinyl acetate resin emulsion), and Polysol PSASE-6010 (ethylene-vinyl acetate resin emulsion), all produced by Showa Denko; Polysol SAE1014 (styrene-acrylic resin emulsion produced by Zeon Corporation); SAIVINOL SK-200 (acrylic resin emulsion produced by Saiden Chemical Industry); AE-120A (acrylic resin emulsion produced by JSR); AE373D (carboxy-modified styrene-acrylic resin emulsion produced by Emulsion Technology Co., Ltd.); SEIKADYNE 1900W (ethylene-vinyl acetate resin emulsion produced by Dainichiseika Color & Chemicals); VINYBLAN 2682 (acrylic resin emulsion), VINYBLAN 2886 (vinyl acetate-acrylic resin emulsion), VINYBLAN 5202 (acetic acid-acrylic resin emulsion), VINYBLAN 700, and VINYBLAN 2586 (all produced by Nissin Chemical Industry); ELITEL series KA-5071S, KT-8803, KT-9204, KT-8701, KT-8904, and KT-0507 (polyester resin emulsions produced by Unitika); HYTEC SN-2002 (polyester resin emulsion produced by Toho Chemical Industry); TAKELAC series W-6020, W-635, W-6061, W-605, W-635, and W-6021 (urethane resin emulsions produced by Mitsui Chemicals); SUPERFLEX series 870, 800, 150, 420, 460, 470, 610, 620, and 700 (urethane resin emulsions produced by DKS); PERMARIN UA-150 (urethane resin emulsion produced by Sanyo Chemical Industries); SANCURE 2710 (urethane resin emulsion produced by Lubrizol); NeoRez series R-9660, R-9637, and R-940 (urethane resin emulsions produced by Kusumoto Chemicals); ADEKA BON-TIGHTER series HUX-380 and 290K (urethane resin emulsions produced by ADEKA); MOWINYL 966A and MOWINYL 7320 (produced by Japan Coating Resin); JONCRYL series 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (produced by BASF); NK Binder R-5HN (produced by Shin-Nakamura Chemical); HYDRAN WLS-210 (non-crosslinked polyurethane produced by DIC); and JONCRYL 7610 (produced by BASF).

The resin particle solid content, if added to the treatment liquid composition, may be 0.1% to 10%, for example, 0.5% to 5.0% or 1.0% to 3.0%, relative to the total mass of the treatment liquid composition. In some embodiments, it may be 1.5% to 2.5% by mass.

The material of the resin particles may be selected from among urethane resin, styrene-acrylic resin, polyolefin resin, and polyester resin from the viewpoint of increasing the adhesion to the cloth and the constituents of the ink jet ink composition, and the resistance to rubbing.

### 1. 4. 2. Other Constituents

Furthermore, the treatment liquid composition may contain the following constituents.

### (1) Surfactant

The treatment liquid composition disclosed herein may contain a surfactant. The surfactant reduces the surface tension of the treatment liquid to adjust or increase the wettability (permeation) to the cloth. The surfactant may be at least one selected from the group consisting of silicones, fluoro compounds, acetylene glycols, and polyoxyethylenes. In the present disclosure, silicone, fluoro compounds, acetylene glycols, and polyoxyethylenes are collectively referred to as surfactants. The surfactant may be cationic.

Silicones, or polysiloxanes, used as the surfactant include polyether-modified organosiloxanes. Polyether-modified organosiloxanes are commercially available, and examples thereof include BYK-028, BYK-306, BYK-307, BYK-333, BYK-341, BYK-345, BYK-346, BYK-347, BYK-348, and BYK-349 (all produced by BYK); KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all produced by Shin-Etsu Chemical); and SILFACE SAG series 002, 005, 503A, and 008 (all produced by Nissin Chemical Industry).

Examples of the fluoro compounds used as the surfactant include, but are not limited to, perfluoroalkylsulfonic acid salts, perfluoroalkylcarboxylic acid salts, perfluoroalkylphosphoric acid esters, perfluoroalkylethylene oxide adducts, perfluoroalkylbetaines, perfluoroalkylamine oxides, and fluorine-modified polymers. Such fluoro compounds are commercially available, and examples thereof include S-144 and S-145 (both produced by Asahi Glass); FC-170C, FC-430, and FLUORAD FC4430 (all produced by 3M); FSO, FSO-100, FSN, FSN-100, and FSN-300 (all produced by Dupont); FT-250 and FT-251 (both produced by Neos); and BYK-340 (produced by BYK).

Examples of the acetylene glycols used as the surfactant include, but are not limited to, SURFYNOL series 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D and DYNOL series 604 and 607 (all produced by Evonik Industries); OLFINE series B, Y, P, A, STG, SPC, E1004, E1010, E1020, PD-001, PD-002W, PD-003, PD-004, PD-005, EXP. 4001, EXP. 4036, EXP. 4051, EXP. 4123, EXP. 4200, EXP. 4300, AF-103, AF-104, AK-02, SK-14, and AE-3 (all produced by Nissin Chemical Industry); and ACETYLENOL series E00, E00P, E40, E60, and E100 (all produced by Kawaken Fine Chemicals).

Examples of polyoxyethylenes used as the surfactant include, but are not limited to, NEWCOL 2300s (such as 2303, 2327, and 2399-S), NEWCOL NTs (such as NT-3, NT-5, NT-7, and NT-9), and NEWCOL 1000s (such as 1004, 1006, 1008, 1203, 1305, and 1525) (all produced by Nippon Nyukazai); EMULGEN series 102KG, 103, 104P, 105, 106, 108, 120, 147, 150, 220, 350, 404, 420, 430, 705, 707, 709, 1108, 4085, and 2025G (all produced by Kao); and polyoxyethylene alkyl ethers, such as polyoxyethylene polyoxypropylene hexyl ether (C₆H₁₃—EO—PO—OH).

Cationic surfactants include primary, secondary, and tertiary amine salts including alkyl amine salts, dialkyl amine salts, and aliphatic amine salts; quaternary ammonium salts, such as benzalkonium salts and other quaternary alkyl ammonium salts; and alkyl pyridinium salts, sulfonium salts, phosphonium salts, onium salts, and imidazolinium salts. More specifically, examples of such a cationic surfactant include hydrochlorides or acetates of laurylamine, palm amine, and rosin amine, lauryltrimethylammonium chloride, cetyltrimethylammonium chloride, benzyltributylammonium chloride, benzalkonium chloride, dimethylethyllaurylammonium ethyl sulfate, dimethylethyloctylammonium ethyl sulfate, trimethyllaurylammonium hydrochloride, cetylpyridinium chloride, cetylpyridinium bromide, dihydroxyethyllaurylamine, decyldimethylammonium chloride, decyldimethylbenzylammonium chloride, dodecyldimethylbenzylammonium chloride, tetradecyldimethylammonium chloride, hexadecyldimethylammonium chloride, and octadecyldimethylammonium chloride.

One or more surfactants may be used individually or in combination. The treatment liquid composition containing such a surfactant is not likely to foam and has a low surface tension. Thus, the use of a surfactant increases the wettability to the cloth and helps textile printing of clear images or patterns. The surfactant content may be 0.05% to 5% relative to the total mass of the treatment liquid composition. In some embodiments, the surfactant content may be, by mass, 0.1% to 5% or 0.2% to 4%.

The treatment liquid composition containing a surfactant tends to be consistent when ejected from the printing head by an ink jet method.

### (2) Water-Soluble Organic Solvent

The treatment liquid composition disclosed herein may further contain a water-soluble organic solvent. The water-soluble organic solvent increases the wettability of the treatment liquid composition to the cloth and the moisture-retaining property of the treatment liquid. The water-soluble organic solvent may be selected from among esters, alkylene glycol ethers, cyclic esters, nitrogen-containing solvents, and polyhydric alcohols. Nitrogen-containing solvents include cyclic amides and acyclic amides. An example of acyclic amides is an alkoxyalkylamide.

Exemplary esters include glycol monoacetates, such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate; and glycol diesters, such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, propylene glycol acetate propionate, propylene glycol acetate butyrate, dipropylene glycol acetate butyrate, and dipropylene glycol acetate propionate.

Exemplary alkylene glycol ethers include alkylene glycol monoethers and alkylene glycol diethers. In some embodiments, alkyl ethers may be used. More specifically, examples of such an alkylene glycol ether include alkylene glycol monoalkyl ethers, such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether; and alkylene glycol dialkyl ethers, such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Exemplary cyclic esters include lactones, such as β-propiolactone, γ-butyrolactone, δ-valerolactone, ϵ-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ϵ-heptanolactone, γ-octanolactone, δ-octanolactone, ϵ-octanolactone, δ-nonalactone, ϵ-nonalactone, and ϵ-decanolactone; and compounds derived from these lactones by substituting an alkyl group having a carbon number of 1 to 4 for the hydrogen of the methylene group adjacent to the carbonyl group of the lactone.

Examples of the alkoxyalkylamide include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-isopropoxy-N,N-dimethylpropionamide, 3-isopropoxy-N,N-diethylpropionamide, 3-isopropoxy-N,N-methylethylpropionamide, 3-tert-butoxy-N,N-dimethylpropionamide, 3-tert-butoxy-N,N-diethylpropionamide, and 3-tert-butoxy-N,N-methylethylpropionamide.

Exemplary cyclic amides include lactams, such as 2-pyrrolidone, 1-methyl-2-pyrrolidone, 1-ethyl-2-pyrrolidone, 1-propyl-2-pyrrolidone, and 1-butyl-2-pyrrolidone.

Exemplary polyhydric alcohols include 1,2-alkanediols, such as ethylene glycol, propylene glycol (also known as propane-1,2-diol), 1,2-butanediol, 1,2-pentanediol, 1,2-hexanediol, 1,2-heptanediol, and 1,2-octanediol; and other polyhydric alcohols (polyols), such as diethylene glycol, dipropylene glycol, triethylene glycol, 1,3-propanediol, 1,3-butanediol (also known as 1,3-butylene glycol), 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylolpropane, and glycerin.

The treatment liquid composition may contain an individual water-soluble organic solvent or two or more water-soluble organic solvents in combination. The total water-soluble organic solvent content in the treatment liquid composition may be, for example, 0.5% to 50.0%, for example, 1.0% to 40.0%, 5.0% to 30.0%, or 10.0% to 20.0%, relative to the total mass of the treatment liquid composition.

### (3) pH Adjuster

The treatment liquid composition disclosed herein may contain a pH adjuster to control the pH. The pH adjuster may be, but is not limited to, an appropriate combination of two or more of the acids, bases, weak acids, and weak bases. The acids and bases used for this combination include inorganic acids, such as sulfuric acid, hydrochloric acid, and nitric acid; inorganic bases, such as lithium hydroxide, sodium hydroxide, potassium hydroxide, potassium dihydrogenphosphate, disodium hydrogenphosphate, potassium carbonate, sodium carbonate, sodium hydrogencarbonate, and ammonia; organic bases, such as triethanolamine, diethanolamine, monoethanolamine, tripropanolamine, triisopropanolamine, diisopropanolamine, and tris(hydroxymethyl)aminomethane (THAM); and organic acids, such as adipic acid, citric acid, succinic acid, and lactic acid. Also, a buffer solution may be used, and examples thereof include Good buffers, phosphate buffers, citrate buffers, and tris buffers. Good buffers include N,N-bis(2-hydroxyethyl)-2-aminoethanesulfonic acid (BES), 4-(2-hydroxyethyl)-1-piperazine ethanesulfonic acid (HEPES), morpholinoethanesulfonic acid (MES), carbamoylmethyliminodiacetic acid (ADA), piperazine-1,4-bis (2-ethanesulfonic acid) (PIPES), N-(2-acetamido)-2-aminoethanesulfonic acid (ACES), cholamine chloride, N-tris(hydroxymethyl)methyl-2-aminoethanesulfonic acid (TES), acetamidoglycine, tricine, glycinamide, and bicine. In some embodiments, a tertiary amine, such as triethanolamine or triisopropanolamine, and a carboxylic acid, such as adipic acid, citric acid, succinic acid, or lactic acid, may be used in combination as one or more or all the pH adjusters. Such a pH adjuster can function stably.

### (4) Urea Compound

The treatment liquid composition may contain a urea compound as a moisturizing agent or a dyeing aid for helping the color material to dye the cloth. Examples of the urea compound include urea, ethyleneurea, tetramethylurea, thiourea, and 1,3-dimethyl-2-imidazolidinone. The urea content, if added, may be 1% to 10% relative to the total mass of the treatment liquid composition.

### (5) Saccharide

From the viewpoint of minimizing solidification and drying of the treatment liquid composition, a saccharide may be added. Examples of the saccharide include glucose, mannose, fructose, ribose, xylose, arabinose, galactose, aldonic acid, glucitol (sorbitol), maltose, cellobiose, lactose, sucrose, trehalose, and maltotriose.

### (6) Chelating Agent

From the viewpoint of removing undesired ions from the treatment liquid composition, a chelating agent may be added. Examples of the chelating agent include ethylenediaminetetraacetic acid and salts thereof (such as disodium dihydrogen ethylenediaminetetraacetate), nitrilotriacetic acid and salts thereof, hexametaphosphates, pyrophosphates, and metaphosphates.

### (7) Preservative and Fungicide

The treatment liquid composition may contain a preservative and/or a fungicide. Examples of the preservative and the fungicide include sodium benzoate, sodium pentachlorophenol, 2-pyridinethiol 1-oxide sodium salt, sodium sorbate, sodium dehydroacetate, and PROXEL CRL, PROXEL BDN, PROXEL GXL, PROXEL XL-2, PROXEL IB, and PROXEL TN (all produced by Lonza), and 4-chloro-3-methylphenol (PREVENTOL CMK produced by Lanxess).

### (8) Rust Preventive

The treatment liquid composition may contain a rust preventive. Examples of the rust preventive include benzotriazole, acid sulfites, sodium thiosulfate, ammonium thioglycolate, diisopropylammonium nitrite, pentaerythritol tetranitrate, and dicyclohexylammonium nitrite. In some embodiments, benzotriazole may be used.

### (9) Other Additives

The treatment liquid composition may further contain other additives, such as a UV absorbent, an antioxidant, an oxygen absorbent, and a solubilizing agent.

### 1. 5. Effects

When being applied to a cloth before printing with an ink jet ink composition, the treatment liquid composition of the present disclosure enhances color development and increases fastness to rubbing.

### 1. 6. Cloth

The treatment liquid composition disclosed herein is used by being applied to a cloth. Examples of the material of the cloth include, but are not limited to, natural fibers, such as cotton, hemp, ramie, linen, sheep wool, and silk; synthetic fibers, such as polypropylene, polyester, acetate, triacetate, polyamide, and polyurethane; biodegradable fibers, such as poly(lactic acid); and mixed fibers of these fibers. Cloths of fibers containing hydroxy groups, such as cotton, may often be used.

Cotton contains cellulose. The isocyanate groups contained in the treatment liquid composition react with the hydroxy groups of the cellulose to form urethane bonds, thus chemically binding some constituents of the treatment liquid and ink jet ink compositions to the cloth. In addition, the cellulose is turned resistant to water by the reaction of the hydroxy groups thereof with isocyanate groups. This is because the reaction with isocyanate inactivates the hydroxy groups. By imparting water resistance to the cellulose, the cloth becomes unlikely to undergo micro-destruction caused by rubbing in a wet condition.

Images or patterns printed on such a cloth are likely to exhibit high fastness to rubbing. The cloth containing cotton fibers may be a cloth made of only cotton fibers or a blended cloth made or woven with cotton fibers and other fibers. Use of such a cloth can produced satisfactory effects.

When an image is printed on a cloth with the treatment liquid composition applied thereto, with an ink jet ink composition containing a disperse color material described later herein, the printed image exhibits highly developed color and high fastness to rubbing. After the application of the treatment liquid composition, the cloth may be dried. Even in such a case, the treatment liquid can produce the same effects.

For drying, the cloth with the treatment liquid composition applied thereto may be blown with air at room temperature or heated by, for example, infrared radiation, contact with a heater or the like, or blowing warm air. In this instance, it is beneficial to dry the cloth to the extent that at least some of the isocyanate groups can remain in the treatment liquid composition. In some embodiments, accordingly, the cloth may be dried by room-temperature blowing or low-temperature heating. If the isocyanate groups are protected, the drying temperature can be set relatively high.

### 2. Printing Method

The printing method of the present disclosure includes an application step of applying an ink jet ink composition containing a disperse color material and resin particles onto a cloth with the treatment liquid composition applied thereto, and a heating step of heating the cloth after the application step.

The ink jet printing apparatus used in the printing method disclosed herein will first be described in outline.

### 2. 1. Ink Jet Printing Apparatus

The ink jet printing apparatus may be a serial type or a line type. In either type, the ink jet printing apparatus includes a printing head. The printing head ejects droplets with a predetermined volume (or mass) of the ink jet ink composition through the nozzles of the head onto the cloth at a predetermined timing while changing the relative position to the cloth, thus applying the ink jet ink composition onto the cloth to form a predetermined image.

The ink jet printing apparatus may optionally include known components, such as a drying unit, a roll unit, and a winding device. In addition, the ink jet printing apparatus may include a transport device to transport the cloth, an image layer-forming unit to print images with predetermined compositions, a drying device, and an overall drying device to heat and blow air over the printed surface.

The transport device may be defined by, for example, one or more rollers. The number of rollers may be plural. A desired number of rollers are provided at desired positions, provided that the transport device can transport the cloth. The transport device may further include a rolling mechanism, a tray, a belt, and a platen.

The image layer-forming unit is operable to eject the ink jet ink composition onto the printing surface of the cloth to print an image layer. The application of the treatment liquid composition is not necessarily performed by using the ink jet printing apparatus and may be by using a spray or a roller. For applying the ink jet ink and treatment liquid compositions onto the cloth, the application order and amount can be varied as desired in a predetermined range. The image layer-forming unit includes a printing head having nozzles arranged in some lines, and the nozzle lines are assigned one for each composition.

The drying device may be used for drying the image layer formed on the cloth and/or removing volatile components from the cloth. A desired number of drying devices may be provided at appropriate positions in view of the application timing of the ink jet ink composition and the path of cloth transport. The image layer may be dried by applying heat to the cloth via the platen, blowing air onto the image on the cloth, or combining both operations. More specifically, the image layer may be dried by, for example, forcible air heating, heat radiation, conduction heating, high-frequency drying, or microwave drying.

### 2. 2. Steps of Printing Method

In the printing method, the application step is performed in such a manner that the ink jet ink composition is ejected from the printing head to be applied to the region of the cloth with the treatment liquid composition applied thereto.

The printing method disclosed herein also includes a step of heating the ink jet ink composition applied onto the cloth after the application step. For the heating step, any appropriate heating device may be used as desired. The heating step may be performed with a heating device of an apparatus or the like other than the ink jet printing apparatus. The heating step dries the printed image and induces a reaction of the isocyanate groups remaining on the cloth to which the treatment liquid composition has been applied. If the isocyanate groups are protected, the heating step releases the protection and induces a reaction.

In the heating step, the cloth may be heated up to a temperature of 30.0° C. to 180.0° C., for example, 50.0° C. to 150.0° C. or 80.0° C. to 120.0° C., in view of the temperature at which the protection of the isocyanate groups can be released.

Thus, the printing method disclosed herein can use the above-described ink jet printing apparatus. Also, the printing method includes a plurality of application steps of applying ink jet ink compositions onto the cloth, and the order and the number of application steps can be set as desired without particular limitation. For use of a plurality of ink jet ink compositions, the ink compositions may be applied to different regions of the cloth or to the same region.

The printing method disclosed herein may further include other steps as desired. For example, the printing method may include a drying step of drying the cloth before the application step. Also, the printing method may include a cleaning step of cleaning the printed cloth after the heating step.

The drying step before the application step is performed for drying the cloth with the treatment liquid composition applied thereto. This drying step may be performed by blowing room-temperature air or by heating. For this heating, infrared radiation, contact with a heater or the like, or blowing warm air may be applied. In the drying step, it is beneficial to dry the cloth to the extent that at least some of the isocyanate groups can remain in the treatment liquid composition. In some embodiments, accordingly, the cloth may be dried by room-temperature blowing or low-temperature heating. If the isocyanate groups are protected, the drying temperature can be set relatively high.

### 3. Composition Set

The composition set disclosed herein includes the treatment liquid composition described above and an ink jet ink composition containing a disperse color material and resin particles. The ink jet ink composition will now be described.

### 3. 1. Ink Jet Ink Composition

The ink jet ink composition of the composition set disclosed herein contains a disperse color material and resin particles.

### 3. 1. 1. Disperse Color Material

The disperse color material is insoluble in solvents and may be a pigment or a disperse dye. The pigment or dye insoluble or poorly soluble in solvents may be, but is not limited to, an inorganic pigment, an organic pigment, an oil dye, or a disperse dye. The hue of the pigment or dye is not limited and may be a process color, such as cyan, magenta, yellow, or black, or a spot color, such as white, a fluorescent color, or a glittering color.

Examples of the inorganic pigment include carbon blacks (C. I. Pigment Black 7), such as furnace black, lamp black, acetylene black, and channel black; iron oxide; titanium oxide; zinc oxide; and silica.

Carbon blacks are commercially available, those produced by Mitsubishi Chemical include No. 2300, 900, MCF88, No. 20B, No. 33, No. 40, No. 45, No. 52, MA7, MA8, MA100, and No. 2200B. Carbon blacks available from Degussa include Color Blacks FW1, FW2, FW2V, FW18, FW200, 5150, S160, and 5170; PRINTEX series 35, U, V, and 140U; and Special Blacks 6, 5, 4A, 4, and 250. Carbon blacks available from Columbia Carbon include CONDUCTEX SC, and Raven series 1255, 5750, 5250, 5000, 3500, 1255, and 700. Carbon blacks available from Cabot include Regal series 400R, 330R, and 660R; Mogul L; MONARCH series 700, 800, 880, 900, 1000, 1100, 1300, and 1400; and ELFTEX 12. Other carbon blacks include BONJET BLACKs CW-1, CW-1S, CW-2, CW-3, and M-800, produced by Orient Chemical Industries.

Examples of the organic pigment include quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, isoindolinone pigments, azomethine pigments, and azo pigments.

Cyan pigments include C. I. Pigment Blues 1, 2, 3, 15:3, 15:4, 15:34, 16, 22, and 60; and C. I. Vat Blues 4 and 60. In some embodiments, the aqueous cyan ink composition may contain at least one selected from among C. I. Pigment Blues 15:3, 15:4, and 60.

Magenta pigments include C. I. Pigment Reds 5, 7, 12, 48(Ca), 48(Mn), 57(Ca), 57:1, 112, 122, 123, 168, 184, and 202; and C. I. Pigment Violet 19. In some embodiments, the aqueous magenta ink composition may contain at least one selected from the group consisting of C. I. Pigment Reds 122, 202, and 209 and C. I. Pigment Violet 19.

Yellow pigments include C. I. Pigment Yellows 1, 2, 3, 12, 13, 14C, 16, 17, 73, 74, 75, 83, 93, 95, 97, 98, 119, 110, 114, 128, 129, 138, 150, 151, 154, 155, 180, and 185. In some embodiments, the aqueous yellow ink composition may contain at least one selected from the group consisting of C. I. Pigment Yellows 74, 109, 110, 128, and 138.

Orange pigments include C. I. Pigment Oranges 36 and 43 and mixtures thereof. Green Pigments include C. I. Pigment Greens 7 and 36 and mixtures thereof.

Any glitter pigment may be used provided that it produces glitter when applied onto a medium. Examples of the glitter pigment include, but are not limited to, particles (metal pigment) of elemental metals or alloys, such as aluminum, silver, gold, platinum, nickel, chromium, tin, zinc, indium, titanium, and copper; and pearl pigments exhibiting pearl luster. Exemplary pearl pigments include titanium dioxide-coated mica, fish scale foil, and bismuth trichloride. These pigments exhibit pearl luster or interference gloss. The glitter pigment may be surface treated to inhibit a reaction with water.

White pigments include metal compounds, such as metal oxides, barium sulfate, and calcium carbonate. Examples of the metal oxides include titanium dioxide, zinc oxide, silica, alumina, and magnesium oxide. Hollow particles may be used as a white pigment.

Any color material that can be dispersed, without being dissolved, in the ink vehicle may be used as the disperse dye or oil dye, and examples thereof include azo dyes, metal complexes, anthraquinone dyes, phthalocyanine dyes, and triarylmethane dyes.

Examples of the disperse dye include C. I. Disperse Reds 60, 82, 86, 66:1, 167:1, and 279; C. I. Disperse Yellows 64, 71, 86, 114, 153, 233, and 245, and 60; C. I. Disperse Blues 27, 60, 73, 77, 77:1, 87, 257, and 367; C. I. Disperse Violets 26, 33, 36, and 57; and C. I. Disperse Oranges 30, 41, and 61.

The above-cited pigments and dyes are merely examples and may be used individually or in combination. A pigment and a dye may be combined.

It is beneficial that the disperse color material keeps stably dispersed in ink. For example, a pigment may be surface-modified into a self-dispersible form by oxidizing or sulfonating the surfaces of the pigment particles with ozone, hypochlorous acid, fuming sulfuric acid, or the like or may be dispersed with a polymer dispersant.

The disperse color material content in the ink jet ink composition may be 2.0% to 7.0%, for example, 3.0% to 7.0% or 4.0% to 7.0%, relative to the total mass of the ink jet ink composition.

When the disperse color material content is 2.0% by mass or more, the printed image exhibits satisfactory color development. Also, when the disperse color material content is 7.0% by mass or less, the color material is not likely to settle, and the ink jet ink composition can be consistently ejected. Even when the disperse color material content is relatively as high as 4.0% to 7.0% by mass, settling is avoided. However, from the viewpoint of avoiding settling, the disperse color material content may be set at 6.5% by mass or less or 5.0% by mass or less.

### 3. 1. 2. Resin Particles

The ink jet ink composition contains resin particles. The same resin particles as those described for the treatment liquid composition are used. The resin particles of the ink jet ink composition may be the same as or different from those of the treatment liquid composition, if added.

The resin particle solid content in the ink jet ink composition may be 0.1% to 10%, for example, 0.5% to 5.0% or 1.0% to 3.0%, relative to the total mass of the ink jet ink composition. In some embodiments, it may be 1.5% to 2.5% by mass.

### 3. 1. 3. Optional Constituents

In addition to the disperse color material and the resin particles, the ink jet ink composition may optionally contain the following constituents: (1) water, (2) surfactant, (3) water-soluble organic solvent, (4) pH adjuster, (5) urea compound, (6) saccharide, (7) chelating agent, (8) preservative or fungicide, (9) rust preventive, and (10) other constituents. These constituents are the same as described for the treatment liquid composition and thus description thereof is omitted.

The water content in the ink jet ink composition may be 40.0% or more, for example, 50.0% or more or 60.0% or more, relative to the total mass of the ink jet ink composition. When the water content is 40.0% by mass or more, the ink jet ink composition has a relatively low viscosity and becomes easy to apply onto the cloth. The upper limit of the water content may be 90.0% or less, for example, 85.0% or less, relative to the total mass of the ink jet ink composition.

The surfactant content may be 0.05% to 5% relative to the total mass of the ink jet ink composition. In some embodiments, the surfactant content may be, by mass, 0.1% to 5% or 0.2% to 4%. The use of a surfactant increases the wettability of the ink jet ink composition to the cloth and helps textile printing of clear images or patterns.

Also, the ink jet ink composition containing a surfactant tends to be consistent when ejected from the printing head. Also, the use of an appropriate amount of surfactant increases the penetration of the ink jet ink composition into the cloth, resulting in increased contact with the treatment liquid.

The ink jet ink composition may contain one or more water-soluble organic solvents. In this instance, the total water-soluble organic solvent content may be 3.0% to 50.0%, for example, 5.0% to 40.0% or 10.0% to 30.0%, relative to the total mass of the treatment liquid composition.

### 3. 1. 4. Preparation and Physical Properties of Ink Jet Ink Composition

The ink jet ink composition may be prepared, but not limited to, by mixing the above-described constituents in any order and, optionally, removing impurities by filtration or the like. For mixing the constituents, for example, the constituents may be added one after another into a container equipped with a stirring device, such as a mechanical stirrer or a magnetic stirrer, and the contents of the container are stirred.

Beneficially, the ink jet ink composition has a surface tension at 20° C. of 20 mN/m to 40 mN/m or 20 mN/m to 35 mN/m from the viewpoint of the balance between the image quality and the reliability as an ink jet printing ink. The surface tension can be determined by measuring the ink composition wetting a platinum plate at 20° C. with, for example, an automatic surface tensiometer CBVP-Z (manufactured by Kyowa Interface Science).

Also, from the same viewpoint, the viscosity at 20° C. of the ink jet ink composition may be 1.0 mPa·s to 20.0 mPa·s or 3.0 mPa·s to 15.0 mPa·s. The viscosity can be measured at 20° C. with, for example, a viscoelasticity meter MCR-300 (manufactured by Pysica).

### 3. 2. Other Compositions

The composition set disclosed herein, which includes the treatment liquid composition and the ink jet ink compositions, may further include other ink jet ink compositions for different colors. In an embodiment, the composition set may include a clear ink composition.

By using the composition set of the disclosure, images having highly developed color with high fastness to rubbing can be formed.

### 4. EXAMPLES

The subject matter of the present disclosure will be further described in detail with reference to the following Examples. However, the implementation of the subject matter of the present disclosure is not limited to the disclosed Examples. In the following description, “%” is on a mass basis unless otherwise specified.

### 4. 1. Preparation of Treatment Liquid Compositions

Tables 1 and 2 present the constituents and the contents thereof in the treatment liquid compositions of the Examples and Comparative Examples. The treatment liquid compositions were prepared by mixing the constituents presented in Tables 1 and 2 with stirring for 30 minutes or more, followed by filtration. For mixing, the constituents were added one after another into a container equipped with a mechanical stirrer and stirred. Then, the mixtures were filtered to yield the treatment liquid compositions of Examples 1 to 18 and Comparative Examples 1 to 8. The content of each constituent in the Tables is in terms of the active constituent.

TABLE 1

| | | | | Example | | | | | |
|---|---|---|---|---|---|---|---|---|---|
| | | | (mass %) | 1 | 2 | 3 | 4 | 5 | 6 |
| Crosslinking | Toluene | Nonionic | MEIKANATE TP-10 | — | — | — | — | — | — |
| agent | diisocyanate | | | | | | | | |
| | derivative | | | | | | | | |
| | Hexamethylene | Nonionic | MEIKANATE NBP-211 | — | — | — | — | — | — |
| | diisocyanate | Cationic | MEIKANATE CX | — | — | — | — | — | — |
| | derivative | Anionic | MEIKANATE SU-268A | — | — | — | — | — | — |
| | | Nonionic | MEIKANATE NBP-873D | 0.2 | 0.5 | 1.0 | 2.0 | 5.0 | 10.0 |
| | Polycarbodiimide | Nonionic | CARBODILITE V-02-L2 | — | — | — | — | — | — |
| | Oxazoline | Nonionic | EPOCROS K-2020E | — | — | — | — | — | — |
| Multivalent | Calcium chloride dihydrate | | Cationic | 2.0 | 2.0 | 2.0 | 2.0 | 2.0 | 2.0 |
| metal salt | Calcium nitrate tetrahydrate | | Cationic | — | — | — | — | — | — |
| Cationic | Polyallylamine | Cationic | PAA-HCL-03 | — | — | — | — | — | — |
| polymer | polymer | | | | | | | | |
| | Polyallylamine | Cationic | PAA-03 | — | — | — | — | — | — |
| | polymer | | | | | | | | |
| Resin | Urethane resin | Cationic | SUPERFLEX SF-620 | — | — | — | — | — | — |
| particles | | | | | | | | | |
| Surfactant | Acetylene glycol | Nonionic | SURFYNOL 485 | 1.0 | 1.0 | 1.0 | 1.0 | 1.0 | 1.0 |
| | Didecyldimethylammonium | | Cationic | — | — | — | — | — | — |
| | chloride | | | | | | | | |
| Preservative | Proxel XL2 | | | 0.2 | 0.2 | 0.2 | 0.2 | 0.2 | 0.2 |
| Dispersion | Pure water | | | Balance | Balance | Balance | Balance | Balance | Balance |
| medium | | | | | | | | | |
| Total | | | | 100 | 100 | 100 | 100 | 100 | 100 |
| Evaluation | Dispersion stability | Leave for 24 hours | | A | A | A | A | A | B |
| | Color development | Black ink, 100% Duty | | A | A | A | A | B | B |
| | Color fastness to | Migration | Dry rubbing | B | B | A | A | A | A |
| | rubbing | | Wet rubbing | C | B | B | B | A | A |
| | | Discoloration/ | Dry rubbing | B | B | A | A | A | A |
| | | Fading | Wet rubbing | C | B | B | B | A | A |
| | | | | Example | | | | | |
| | | | (mass %) | 7 | 8 | 9 | 10 | 11 | 12 |
| Crosslinking | Toluene | Nonionic | MEIKANATE TP-10 | — | — | — | — | — | — |
| agent | diisocyanate | | | | | | | | |
| | derivative | | | | | | | | |
| | Hexamethylene | Nonionic | MEIKANATE NBP-211 | — | — | 2.0 | — | — | — |
| | diisocyanate | Cationic | MEIKANATE CX | — | 2.0 | — | — | — | — |
| | derivative | Anionic | MEIKANATE SU-268A | 2.0 | — | — | — | — | — |
| | | Nonionic | MEIKANATE NBP-873D | — | — | — | 2.0 | 2.0 | 2.0 |
| | Polycarbodiimide | Nonionic | CARBODILITE V-02-L2 | — | — | — | — | — | — |
| | Oxazoline | Nonionic | EPOCROS K-2020E | — | — | — | — | — | — |
| Multivalent | Calcium chloride dihydrate | | Cationic | 2.0 | 2.0 | 2.0 | — | — | — |
| metal salt | Calcium nitrate tetrahydrate | | Cationic | — | — | — | 2.0 | — | — |
| Cationic | Polyallylamine | Cationic | PAA-HCL-03 | — | — | — | — | 0.5 | 1.0 |
| polymer | polymer | | | | | | | | |
| | Polyallylamine | Cationic | PAA-03 | — | — | — | — | — | — |
| | polymer | | | | | | | | |
| Resin | Urethane resin | Cationic | SUPERFLEX SF-620 | — | — | — | — | — | — |
| particles | | | | | | | | | |
| Surfactant | Acetylene glycol | Nonionic | SURFYNOL 485 | 1.0 | 1.0 | 1.0 | 1.0 | 1.0 | 1.0 |
| | Didecyldimethylammonium | | Cationic | — | — | — | — | — | — |
| | chloride | | | | | | | | |
| Preservative | Proxel XL2 | | | 0.2 | 0.2 | 0.2 | 0.2 | 0.2 | 0.2 |
| Dispersion | Pure water | | | Balance | Balance | Balance | Balance | Balance | Balance |
| medium | | | | | | | | | |
| Total | | | | 100 | 100 | 100 | 100 | 100 | 100 |
| Evaluation | Dispersion stability | Leave for 24 hours | | B | A | A | A | B | A |
| | Color development | Black ink, 100% Duty | | A | A | A | A | A | A |
| | Color fastness to | Migration | Dry rubbing | B | B | A | A | A | A |
| | rubbing | | Wet rubbing | C | C | B | B | A | B |
| | | Discoloration/ | Dry rubbing | B | B | B | A | A | A |
| | | Fading | Wet rubbing | C | C | B | B | A | B |

TABLE 2

| | | | | Example | | | | | |
|---|---|---|---|---|---|---|---|---|---|
| | | | (mass %) | 13 | 14 | 15 | 16 | 17 | 18 |
| Crosslinking | Toluene | Nonionic | MEIKANATE TP-10 | — | — | — | — | — | — |
| agent | diisocyanate | | | | | | | | |
| | derivative | | | | | | | | |
| | Hexamethylene | Nonionic | MEIKANATE NBP-211 | — | — | — | — | — | — |
| | diisocyanate | Cationic | MEIKANATE CX | — | — | — | — | — | — |
| | derivative | Anionic | MEIKANATE SU-268A | — | — | — | — | — | — |
| | | Nonionic | MEIKANATE NBP-873D | 2.0 | 2.0 | 2.0 | 2.0 | 1.0 | 2.0 |
| | Polycarbodiimide | Nonionic | CARBODILITE V-02-L2 | — | — | — | — | — | — |
| | Oxazoline | Nonionic | EPOCROS K-2020E | — | — | — | — | — | — |
| Multivalent | Calcium chloride dihydrate | | Cationic | — | — | — | 1.0 | 2.0 | 2.0 |
| metal salt | Calcium nitrate tetrahydrate | | Cationic | — | — | — | — | — | — |
| Cationic | Polyallylamine | Cationic | PAA-HCL-03 | 2.0 | 5.0 | — | — | — | — |
| polymer | polymer | | | | | | | | |
| | Polyallylamine | Cationic | PAA-03 | — | — | 2.0 | 1.0 | — | — |
| | polymer | | | | | | | | |
| Resin | Urethane resin | Cationic | SUPERFLEX SF-620 | — | — | — | — | 1.0 | — |
| particles | | | | | | | | | |
| Surfactant | Acetylene glycol | Nonionic | SURFYNOL 485 | 1.0 | 1.0 | 1.0 | 1.0 | 1.0 | — |
| | Didecyldimethylammonium | | Cationic | — | — | — | — | — | — |
| | chloride | | | | | | | | |
| Preservative | Proxel XL2 | | | 0.2 | 0.2 | 0.2 | 0.2 | 0.2 | 0.2 |
| Dispersion | Pure water | | | Balance | Balance | Balance | Balance | Balance | Balance |
| medium | | | | | | | | | |
| Total | | | | 100 | 100 | 100 | 100 | 100 | 100 |
| Evaluation | Dispersion stability | Leave for 24 hours | | A | A | A | A | A | A |
| | Color development | Black ink, 100% Duty | | A | A | A | A | A | B |
| | Color fastness to | Migration | Dry rubbing | A | B | A | A | A | A |
| | rubbing | | Wet rubbing | B | B | B | B | B | A |
| | | Discoloration/ | Dry rubbing | A | B | A | A | A | A |
| | | Fading | Wet rubbing | B | B | B | B | B | A |
| | | | | Comparative Example | | | | | |
| | | | (mass %) | 1 | 2 | 3 | 4 | 5 | 6 |
| Crosslinking | Toluene | Nonionic | MEIKANATE TP-10 | 2.0 | — | — | — | — | — |
| agent | diisocyanate | | | | | | | | |
| | derivative | | | | | | | | |
| | Hexamethylene | Nonionic | MEIKANATE NBP-211 | — | — | — | — | — | — |
| | diisocyanate | Cationic | MEIKANATE CX | — | — | — | — | — | — |
| | derivative | Anionic | MEIKANATE SU-268A | — | — | — | — | — | — |
| | | Nonionic | MEIKANATE NBP-873D | — | — | — | 2.0 | | 2.0 |
| | Polycarbodiimide | Nonionic | CARBODILITE V-02-L2 | — | 2.0 | — | — | — | — |
| | Oxazoline | Nonionic | EPOCROS K-2020E | — | — | 2.0 | — | — | — |
| Multivalent | Calcium chloride dihydrate | | Cationic | 2.0 | 2.0 | 2.0 | — | 2.0 | — |
| metal salt | Calcium nitrate tetrahydrate | | Cationic | — | — | — | — | — | — |
| Cationic | Polyallylamine | Cationic | PAA-HCL-03 | — | — | — | — | — | — |
| polymer | polymer | | | | | | | | |
| | Polyallylamine | Cationic | PAA-03 | — | — | — | — | — | — |
| | polymer | | | | | | | | |
| Resin | Urethane resin | Cationic | SUPERFLEX SF-620 | — | — | — | — | — | — |
| particles | | | | | | | | | |
| Surfactant | Acetylene glycol | Nonionic | SURFYNOL 485 | 1.0 | 1.0 | 1.0 | — | 1.0 | 1.0 |
| | Didecyldimethylammonium | | Cationic | — | — | — | 2.0 | — | — |
| | chloride | | | | | | | | |
| Preservative | Proxel XL2 | | | 0.2 | 0.2 | 0.2 | 0.2 | 0.2 | 0.2 |
| Dispersion | Pure water | | | Balance | Balance | Balance | Balance | Balance | Balance |
| medium | | | | | | | | | |
| Total | | | | 100 | 100 | 100 | 100 | 100 | 100 |
| Evaluation | Dispersion stability | Leave for 24 hours | | A | A | C | A | A | A |
| | Color development | Black ink, 100% Duty | | A | C | — | C | A | C |
| | Color fastness to | Migration | Dry rubbing | C | C | — | A | C | A |
| | rubbing | | Wet rubbing | D | D | — | B | D | B |
| | | Discoloration/ | Dry rubbing | C | C | — | A | C | A |
| | | Fading | Wet rubbing | D | D | — | B | D | B |

The constituents presented in Tables 1 and 2 are as follows:
Toluene diisocyanate derivative (nonionic) MEIKANATE TP-10 (not an aliphatic diisocyanate, but an aromatic diisocyanate), produced by Meisei Chemical Works
Hexamethylene diisocyanate derivative (nonionic) MEIKANATE NBP-211 (aliphatic diisocyanate), produced by Meisei Chemical Works
Hexamethylene diisocyanate derivative (cationic) MEIKANATE CX (aliphatic diisocyanate), produced by Meisei Chemical Works
Hexamethylene diisocyanate derivative (anionic) MEIKANATE SU-268A (aliphatic diisocyanate), produced by Meisei Chemical Works
Hexamethylene diisocyanate derivative (nonionic): MEIKANATE NBP-873D (aliphatic diisocyanate), produced by Meisei Chemical Works
Polycarbodiimide (nonionic) CARBODILITE V-02-L2 (not aliphatic diisocyanate), produced by Nisshinbo Chemical
Oxazoline (nonionic) EPOCROS K-2020E (not aliphatic diisocyanate), produced by Nippon Shokubai
Calcium chloride dihydrate (cationic) reagent, flocculant (multivalent metal salt)
Calcium nitrate tetrahydrate (cationic) reagent, flocculant (multivalent metal salt)
Polyallylamine polymer (cationic) PAA-HCL-03, flocculant (cationic polymer), produced by Nittobo Medical
Polyallylamine polymer (cationic) PAA-03, flocculant (cationic polymer), produced by Nittobo Medical
Urethane resin (cationic) SUPERFLEX SF-620 (resin particles), produced by DKS
Acetylene glycol (nonionic) SURFYNOL 485 (acetylene glycol surfactant, produced by Evonik Industries
Didecyldimethylammonium chloride (cationic) reagent (cationic surfactant)

### 4. 2. Evaluation

### 4. 2. 1. Dispersion stability

After preparation, 20 mL of the treatment liquid composition of each Example was placed into a 30 mL glass bottle and allowed to stand for 24 hours. The treatment liquid composition after standing was observed under a visible light source and checked for a deposit or suspended matter. The samples subjected to such visual observation were rated according to the following criteria, and the results are presented in the Tables.

A: No deposit nor suspended matter was seen.

B: No clear deposit nor suspended matter was seen, but the concentration of the composition was uneven.

C: Some clear deposit or suspended matter was seen.

### 4. 2. 2. Color Development

In each of the Examples and Comparative Examples, a black ink jet ink composition was applied onto a cloth with the corresponding treatment liquid composition applied thereto, by an ink jet method using an ink jet printer (PX-G930 manufactured by Seiko Epson). A solid pattern (duty: 100%) was printed in a region of 210 mm×297 mm at a resolution of 1440 dpi×720 dpi. The cloth printed with the ink jet ink composition was dried by heating at 160° C. for 5 minutes in a conveyor drying oven Economax D (manufactured by M & R), followed by cooling to 25° C. Thus, printed textiles were obtained.

The cloth used was a cotton cloth COT-BK CT003 (manufactured by For. Tex), and the composition of the black ink jet ink composition was as follows. The contents of the pigment, the resin particles, and the slip additive are in terms of solids.
Carbon Black (BONJET BLACKCW-1, produced by Orient Chemical Industries, pigment solids: 20%): 5.0% by mass
Urethane resin particles containing crosslinkable groups (ETERNACOLL UW-1501F, produced by Ube Industries, Tg: -30° C., average particles size D50: 40 nm): 7.0% by mass
Slip additive (HYTEC E-6500, produced by Toho Chemical Industry, melting point: 140° C., average particle size D50: 60 nm, polyethylene wax emulsion): 1.0% by mass
Glycerol: 10.0% by mass
Triethylene glycol: 5.0% by mass
Potassium hydroxide: 0.1% by mass
Acetylene glycol-based surfactant (OLFINE E1010, produced by Nisshin Chemical Industry): 0.3% by mass
Ion-exchanged water: balance

The optical densities (ODs) of the images of the resulting printed cloths were measured with a colorimeter FD-7 (manufactured by Konica Minolta) for evaluation of color development. The measured ODs were evaluated according to the following criteria, and the results are presented in the Tables. The sign “-” in the Tables represents that the evaluation of color development was impossible because the treatment liquid was not able to be uniformly applied to the cloth.

A: OD was 1.4 or more.

B: OD was 1.25 to less than 1.4.

C: OD was less than 1.25.

### 4. 2. 3. Fastness to Rubbing

The cloths printed at a duty of 100% were subjected to wet and dry rubbing tests in accordance with ISO 105-X12, and the fastness was evaluated in the same manner as in the evaluation of color development and rated according to the following criteria. The results are presented in the Tables. The sign “-” in the Tables represents that the evaluation of fastness was impossible because the treatment liquid was not able to be uniformly applied to the cloth.
Color Migration (Fastness to Dry Rubbing)

A: The difference between ODs before and after the rubbing test was less than 0.15. (excellent)

B: The difference between ODs before and after the rubbing test was 0.15 to less than 0.20. (good)

C: The difference between ODs before and after the rubbing test was 0.20 to less than 0.25.

D: The difference between ODs before and after the rubbing test was 0.25 or more.
A: The difference between ODs before and after the rubbing test was less than 0.20. (excellent)

B: The difference between ODs before and after the rubbing test was 0.20 to less than 0.25. (good)

C: The difference between ODs before and after the rubbing test was 0.25 to less than 0.30.

D: The difference between ODs before and after the rubbing test was 0.30 or more.
Discoloration/Fading (Fastness to Dry Rubbing)

A: The difference between ODs before and after the rubbing test was less than 0.15. (excellent)

B: The difference between ODs before and after the rubbing test was 0.15 to less than 0.20. (good)

C: The difference between ODs before and after the rubbing test was 0.20 to less than 0.25.

D: The difference between ODs before and after the rubbing test was 0.25 or more.
Discoloration/Fading (Fastness to wet rubbing)

A: The difference between ODs before and after the rubbing test was less than 0.20. (excellent)

B: The difference between ODs before and after the rubbing test was 0.20 to less than 0.25. (good)

C: The difference between ODs before and after the rubbing test was 0.25 to less than 0.30.

D: The difference between ODs before and after the rubbing test was 0.30 or more.

### 4. 3. Evaluation Results

In each of the Examples and Comparative Examples, in which the treatment liquid composition containing an aliphatic diisocyanate, at least one selected from the multivalent metal salts and cationic polymers, and water was applied to the cloth in advance, both the color development and the rub fastness of the cloth printed with the ink jet ink composition were satisfactory.

The reason for such results of the Examples is probably because the flocculant in the treatment liquid forms aggregates of the disperse color material when the ink jet ink composition is applied onto the cloth with the treatment liquid composition applied thereto, and holds the color material at the surface of the cloth, thus enhancing color development. It is also because the isocyanate groups of the aliphatic diisocyanate react with at least one of the cellulose in the cloth, the resin particles in the treatment liquid and ink jet ink compositions, and the disperse color material in the ink jet ink composition to form chemical bonds, thus increasing the fastness to rubbing.

In contrast, in Comparative Examples 1 to 3 and 5, using treatment liquids not containing an aliphatic diisocyanate, the printed cloths were insufficient in at least either color development or rub fastness. In Comparative Examples 4 and 6, using treatment liquids not containing a multivalent metal salt or a cationic polymer, color development was insufficient.

Also, the results of Comparative Example 1 suggest that the use of a treatment liquid composition containing an aromatic diisocyanate instead of the aliphatic diisocyanate results in insufficient rub fastness, particularly fastness to wet rubbing. In Comparative Examples 2 to 5, a crosslinking reaction was seemed to occur, but the rub fastness was poor. This suggests that the use of an aliphatic diisocyanate enables the crosslinking reaction to proceed in a condition suitable for increasing the water resistance of the cotton fibers. The water resistance of the cotton fibers is established by inactivation of the hydroxy groups of the cellulose fibers resulting from a reaction with the isocyanate groups in the treatment liquid composition. When the treatment liquid is applied to the cloth, the aliphatic diisocyanate is more likely than aromatic diisocyanates to form uniform coatings over the cellulose fibers. Thus, it is believed that the use of an aliphatic diisocyanate enables the reaction between the hydroxy groups of the cellulose fibers and the isocyanate groups to proceed uniformly and thus increases fastness to rubbing.

The above-described embodiments and modifications are merely examples and do not limit the implementation of the disclosure. For example, an embodiment of the disclosure may be combined with a modification.

The subject matter disclosed herein may be implemented in substantially the same manner as any of the disclosed embodiments (for example, in terms of function, method, and results, or in terms of purpose and effect). Some elements used in the disclosed embodiments but not essential may be replaced. Implementations capable of producing the same effect as produced in the disclosed embodiments or achieving the same object as in the disclosed embodiments are also within the scope of the subject matter of the present disclosure. A combination of any of the disclosed embodiments with a known art is also within the scope of the subject matter of the present disclosure.

The above-described embodiments and modifications derive the following.

The treatment liquid composition according to an aspect is used by being applied to a cloth and contains an aliphatic diisocyanate, at least one compound selected from the group consisting of multivalent metal salts and cationic polymers, and water.

When being applied to a cloth before printing with an ink jet ink composition, the treatment liquid composition enhances color development and increases fastness to rubbing.

The aliphatic diisocyanate added to the treatment liquid composition may be in the form of a cationic or nonionic dispersion in water.

The treatment liquid thus prepared is stable in a stable dispersion and can be stably preserved for a long time.

In the treatment liquid composition, the aliphatic diisocyanate may contain a blocked isocyanate group.

Such a treatment liquid composition keeps the isocyanate group stable and is thus likely to maintain reactivity for a long time.

In the treatment liquid composition, the aliphatic diisocyanate may be an alkylene diisocyanate.

The use of such a treatment liquid composition provides images having highly developed color with high fastness to rubbing.

The cloth to which the treatment liquid composition is to be applied may contain fibers having hydroxy groups.

In this instance, the hydroxy groups of the fibers are likely to react with the isocyanate groups of the diisocyanate, thus increasing the fastness to rubbing of the printed image.

The treatment liquid composition may further contain resin particles.

The use of such a treatment liquid composition provides images having further increased fastness to rubbing.

The printing method according to an aspect includes an application step of applying an ink jet ink composition containing a disperse color material and resin particles onto a cloth with the treatment liquid composition applied thereto, and a heating step of heating the cloth after the application step.

This printing method provides images having highly developed color with high fastness to rubbing.

The printing method may further include a drying step of drying the cloth before the application step.

Such a printing method provides images having further increased fastness to rubbing.

The composition set according to an aspect includes the treatment liquid composition of an embodiment and an ink jet ink composition containing a disperse color material and resin particles.

The use of this composition set provides images having highly developed color with high fastness to rubbing.

The cloth according to an aspect is that with the treatment liquid composition applied thereto.

Images printed on this cloth with an ink composition containing a disperse color material exhibit both high color development and high fastness to rubbing.

What is claimed is:

1. A treatment liquid composition used by being applied to a cloth, the treatment liquid composition comprising:
an aliphatic diisocyanate;
at least one compound selected from the group consisting of multivalent metal salts and cationic polymers; and
water.

2. The treatment liquid composition according to claim 1, wherein
the aliphatic diisocyanate is added in a state of a cationic or nonionic dispersion in water.

3. The treatment liquid composition according to claim 1, wherein
the aliphatic diisocyanate contains a blocked isocyanate group.

4. The treatment liquid composition according to claim 1, wherein
the aliphatic diisocyanate is an alkylene diisocyanate.

5. The treatment liquid composition according to claim 1, wherein
the cloth contains fibers having a hydroxy group.

6. The treatment liquid composition according to claim 1, further comprising resin particles.

7. A printing method comprising:
an application step of applying an ink jet ink composition containing a disperse color material and resin particles onto a cloth with the treatment liquid composition as set forth in claim 1 applied thereto; and
a heating step of heating the cloth after the application step.

8. The printing method according to claim 7, further comprising a drying step of drying the cloth before the application step.

9. A composition set comprising:
the treatment liquid composition as set forth in claim 1; and
an ink jet ink composition containing a disperse color material and resin particles.

10. A cloth with the treatment liquid composition as set forth in claim 1 applied thereto.
